(19) United States
(12) Patent Application Publication
(10) Pub. No.: US 2002/0138641 A1
(43) Pub. Date: Sep. 26, 2002

(54) Targeted multimedia proxy server (tmps)

(76) Inventors: Christopher Stephen Taylor, Shoreline, WA (US); Fredric Norman Doddridge, South Jordan, UT (US); Gregory Allan Martin JR., Bellevue, WA (US); Lance Anthony Neubauer, Shoreline, WA (US)

Correspondence Address: BANNER & WITCOFF, 1001 G STREET N W, SUITE 1100, WASHINGTON, DC, 20001, US

(21) Appl. No.: 09/817,802

(22) Filed: Mar. 26, 2001

(51) Int. Cl. G06F 15/16; H04N 7/173

(52) U.S. Cl. 709/231; 725/86; 709/203

(57) ABSTRACT

A method and system for continuously playing media clips while dynamically assembling and changing the media clips to be played is provided. The method involves creating a dummy play list that causes a media player to request media clips from a proxy server. When the proxy server receives a request for a media clip, it redirects the request to a media content server. Because the proxy server may dynamically determine where to redirect the request, the sequence of media clips the media player plays may be dynamically arranged. Because the media player has what appears to be a complete play list, it can perform buffering to reduce or eliminate gaps between media clips.

### FIELD OF THE INVENTION

The present invention relates generally to computer-executable software, and more particularly to streaming media across a network.

### BACKGROUND

As more and more industries embrace the Internet, the Internet is being used to deliver content, such as video, advertising, and audio, that has historically been broadcast using other mediums. At the same time, the content delivered has changed from a standard broadcast delivered to all recipients to content tailored to a user's tastes and preferences. For example, a broadcast may include live audio clips, advertising, a particular style of entertainment music, and news flashes assembled to meet the needs of a particular audience.

With this need for flexibility in delivering content, challenges in providing a seamless, yet flexible presentation, have arisen. Using standard techniques, for example, a producer may assemble a play list and distribute it to users, but once distributed, the producer is not free to modify the play list. Thus, if a producer wants to send an announcement, advertising, or a news flash, the producer must wait until the user asks for a new play list before distributing the content.

Alternatively, a user may be provided with a system that requests a new media clip after a current media clip has completed. Such a system may allow a producer to insert media clips the producer had not originally planned for, but typically such systems also have at least one drawback: because of latencies on the Internet, there may be several seconds of delay between the completion of one media clip and the starting of another. This delay may not be as annoying when each media clip is relatively long, but when a program includes several small media clips, such as a 10 second introduction, a 20 second advertisement, a 30 second news flash, etc., a delay of a few seconds between each media clip is undesirable.

Assembling media on a server that then broadcasts the media to users may allow a producer to insert dynamic content, but all users are required to listen to the same content, and this model does not scale well as more and more users “tune in” to the server.

Thus, there is a need for a system that allows a media producer to dynamically string media clips together while reducing or eliminating delay between media clips.

### SUMMARY

The present invention provides a method and system for dynamically assembling and changing media clips in a presentation while reducing or eliminating delays between media clips. The method and system works with a variety of streaming media players.

In one aspect of the invention, a play list is given to a client that instructs the client to return to a server to request each media clip. By redirecting the client's request to a media clip on an appropriate media content server, the server may dynamically assemble a media presentation. Because the client is given what appears to be a complete play list, however, the streaming audio player is able to buffer media clips such that delays between media clips are reduced or eliminated.

In another aspect of the invention, a play list is given to the client wherein the play list contains references to additional information that is supplied and that may be generated when the client requests it. The additional information directs the client to a media clip on a media content server to create a dynamic media presentation. Again, because the client is given what appears to be a complete play list, the streaming audio player is able to buffer media clips such that delays between media clips are reduced or eliminated.

The present invention works with standard streaming media players. It avoids problems of scalability by allowing requests for media clips to be redirected to various servers containing media content. It allows a media producer to dynamically assemble and insert media clips while eliminating or reducing delays between media clips.

### BRIEF DESCRIPTION OF THE DRAWINGS

FIGS. 1-3 illustrate an exemplary environment for practicing the invention;

FIG. 4 shows an exemplary system in which the invention operates;

FIG. 5 illustrates an exemplary partial play list for playing media clips;

FIG. 6 shows a logical flow diagram illustrating a process for providing media content dynamically; and

FIG. 7 shows a logical flow diagram illustrating a process for selecting media content automatically or manually, in accordance with the invention.

### DETAILED DESCRIPTION

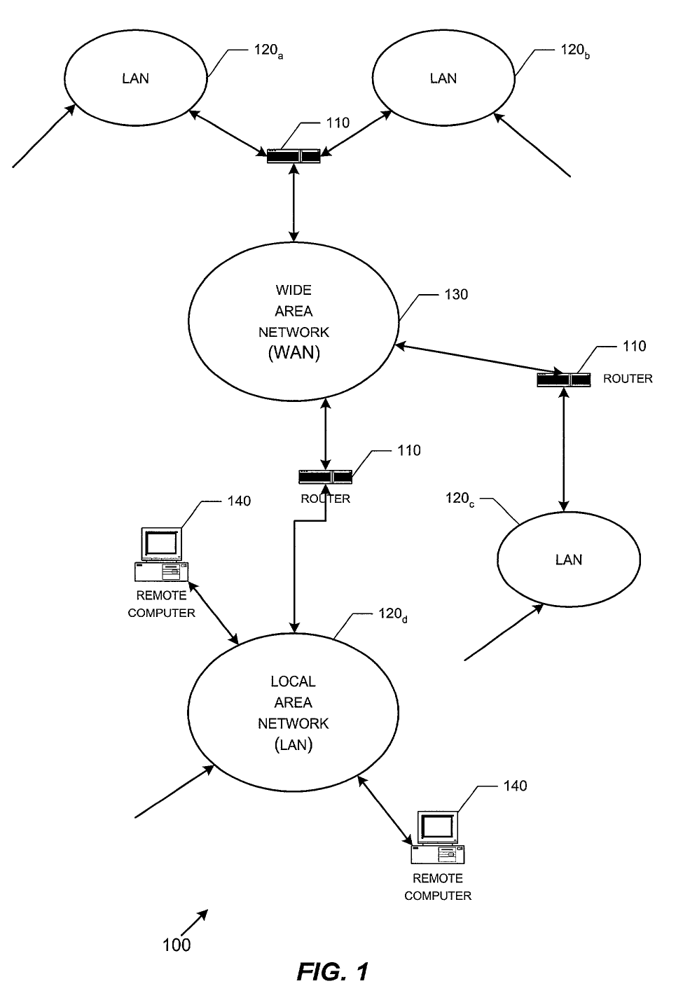

FIGS. 1-3 illustrate an exemplary environment for practicing the invention. Aspects of the present invention are embodied in a World Wide Web (WWW) site accessible via the Internet. Generally, the term “Internet” refers to the worldwide collection of networks and gateways that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and messages. A representative section of the Internet 100 is shown in FIG. 1.

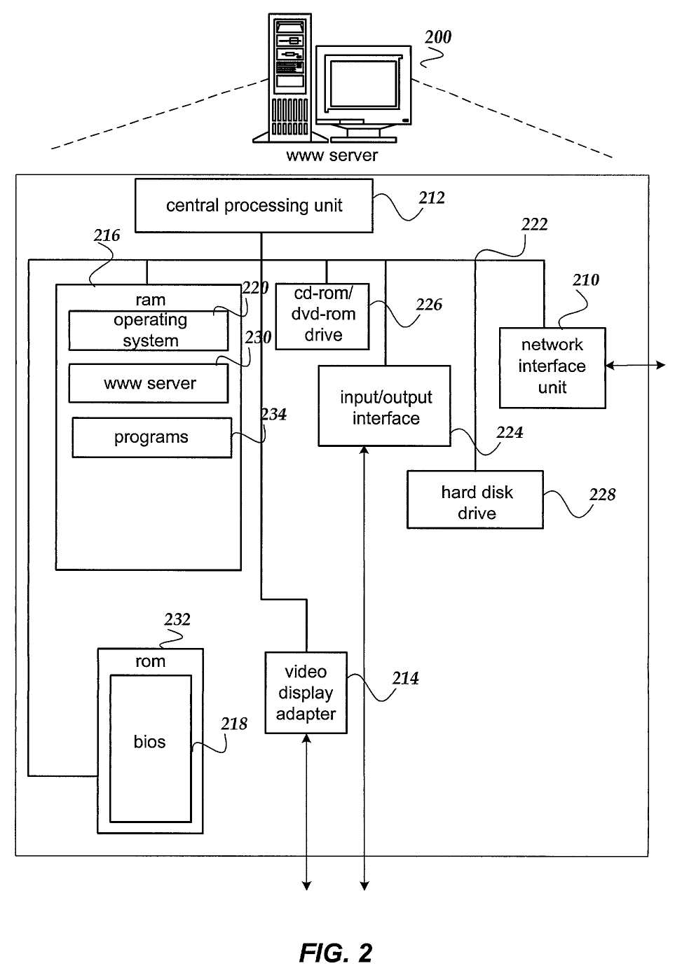

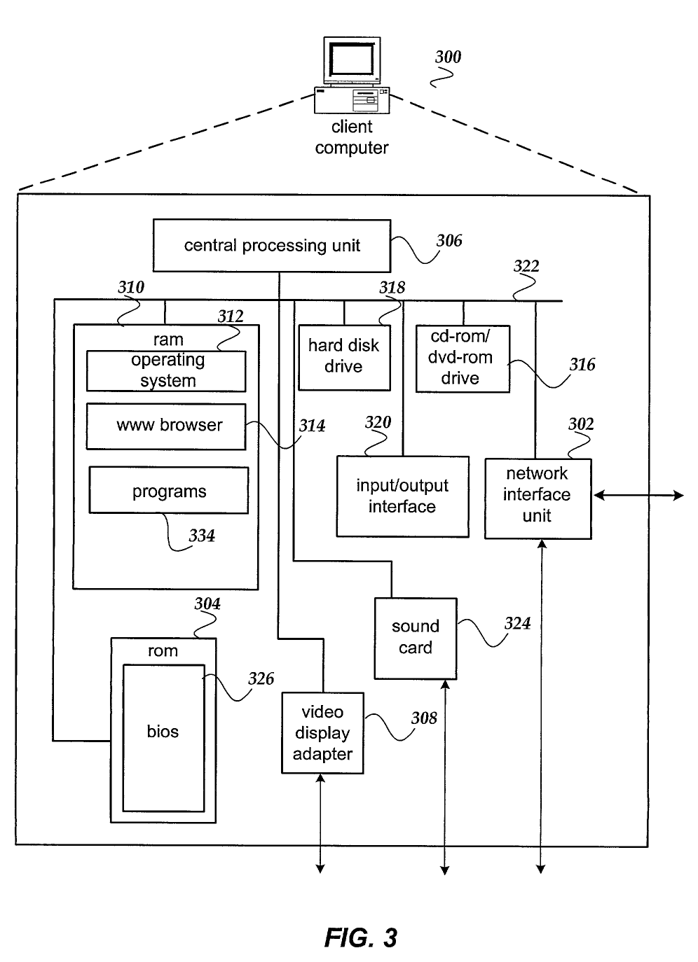

FIG. 1 shows a plurality of local area networks (“LANs”) 120_{a-d} and wide area network (“WAN”) 130 interconnected by routers 110. Routers 110 are intermediary devices on a communications network that expedite message delivery. On a single network linking many computers through a mesh of possible connections, a router receives transmitted messages and forwards them to their correct destinations over available routes. On an interconnected set of LANs—including those based on differing architectures and protocols—, a router acts as a link between LANs, enabling messages to be sent from one to another. Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, computers, such as remote computer 140, and other related electronic devices can be remotely connected to either LANs 120 or WAN 130 via a modem and temporary telephone link. A remote computer may act in a number of ways, including as a WWW server as described in FIG. 2 or a client computer as described in FIG. 3. It will be appreciated that the Internet 100 comprises a vast number of such interconnected networks, computers, and routers and that only a small, representative section of the Internet 100 is shown in FIG. 1.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media. The Internet 100 may include networks constructed from, coupled to, or connected with any type or combination of communication media.

The Internet has recently seen explosive growth by virtue of its ability to link computers located throughout the world. As the Internet has grown, so has the WWW. Generally, the WWW is the total set of interlinked hypertext documents residing on HTTP servers around the world. Documents on the WWW, called pages or Web pages, are typically written in HTML (Hypertext Markup Language) or some other markup language, identified by URLs (Uniform Resource Locators) that specify the particular machine and pathname by which a file can be accessed, and transmitted from server to end user using HTTP (Hypertext Transfer Protocol). Codes, called tags, embedded in an HTML document associate particular words and images in the document with URLs so that a user can access another file, which may literally be halfway around the world, at the press of a key or the click of a mouse. These files may contain text (in a variety of fonts and styles), graphics images, movie files, media clips, and sounds as well as Java applets, ActiveX controls, or other embedded software programs that execute when the user activates them. A user visiting a Web page also may be able to download files from an FTP site and send messages to other users via email by using links on the Web page.

A WWW server is a computer connected to the Internet having storage facilities for storing hypertext documents for a WWW site and running administrative software for handling requests for the stored hypertext documents. A hypertext document normally includes a number of hyperlinks, i.e., highlighted portions of text which link the document to another hypertext document possibly stored at a WWW site elsewhere on the Internet. Each hyperlink is associated with a URL that provides the location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA programming language from Sun Microsystems, for execution on a remote computer. Likewise, a WWW server may also include facilities for executing scripts and other application programs on the WWW server itself.

A user may retrieve hypertext documents from the WWW via a WWW browser application program. A WWW browser, such as Netscape's NAVIGATOR® or Microsoft's INTERNET EXPLORER®, is a software application program for providing a graphical user interface to the WWW. Upon request from the user via the WWW browser, the WWW browser accesses and retrieves the desired hypertext document from the appropriate WWW server using the URL for the document and HTTP. HTTP is a higher-level protocol than TCP/IP and is designed specifically for the requirements of the WWW. HTTP is used to carry requests from a browser to a Web server and to transport pages from Web servers back to the requesting browser or client. The WWW browser may also retrieve application programs from the WWW server, such as JAVA applets, for execution on a client computer.

FIG. 2 shows an exemplary WWW server 200 that is operative to provide a WWW site. Accordingly, WWW server 200 transmits WWW pages to the WWW browser application program executing on client computer 300 (FIG. 3) to carry out this process. For instance, WWW server 200 may transmit pages and forms for receiving information about a user, such as address, telephone number, billing information, credit card number, etc. Moreover, WWW server 200 may transmit WWW pages to client computer 300 that allow a consumer to participate in a WWW site. The transactions may take place over the Internet 100 or some other communications network known to those skilled in the art.

Those of ordinary skill in the art will appreciate that the WWW server 200 may include many more components than those shown in FIG. 2. However, the components shown are sufficient to disclose an illustrative embodiment for practicing the present invention. As shown in FIG. 2, WWW server 200 is connected to Internet 100, or other communications network, via network interface unit 210. Those of ordinary skill in the art will appreciate that network interface unit 210 includes the necessary circuitry for connecting WWW server 200 to Internet 100, and is constructed for use with various communication protocols including the TCP/IP protocol. Typically, network interface unit 210 is a card contained within WWW server 200.

WWW server 200 also includes processing unit 212, video display adapter 214, and a mass memory, all connected via bus 222. The mass memory generally includes RAM 216, ROM 232, and one or more permanent mass storage devices, such as hard disk drive 228, tape drive, optical drive 226, and/or floppy disk drive. The mass memory stores operating system 220 for controlling the operation of WWW server 200. It will be appreciated that this component may comprise a general purpose server operating system as is known to those of ordinary skill in the art, such as UNIX, LINUX™, or Microsoft WINDOWS NT®. Basic input/output system (“BIOS”) 232 is also provided for controlling the low-level operation of WWW server 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

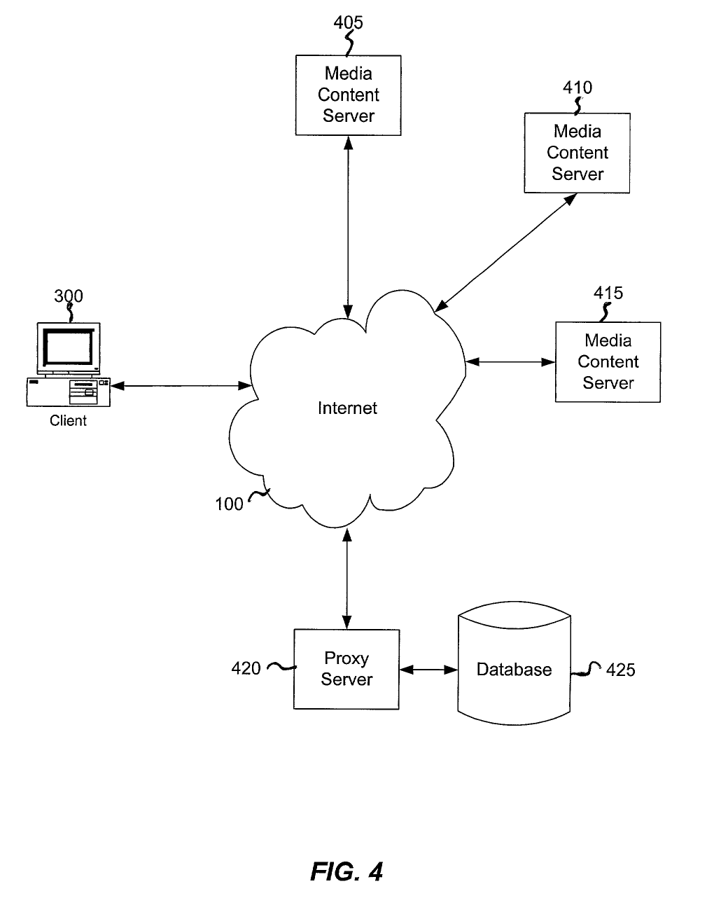

The mass memory also stores program code and data for providing a WWW site. More specifically, the mass memory stores applications including WWW server application program 230. WWW server application program 230 includes computer executable instructions which, when executed by WWW server computer 200, generate WWW browser displays, including performing the logic described above. WWW server application program 230 may also create and transmit media play lists or transmit media clips as described in conjunction with FIG. 4. WWW server 200 may include a JAVA virtual machine, an SMTP handler application for transmitting and receiving e-mail, an HTTP handler application for receiving and handing HTTP requests, JAVA applets for transmission to a WWW browser executing on a client computer, and an HTTPS handler application for handling secure connections. The HTTPS handler application may initiate communication with an external security application or a credit card processing application for communicating with remote financial institutions in a secure fashion.

WWW server 200 also comprises input/output interface 224 for communicating with external devices, such as a mouse, keyboard, scanner, or other input devices not shown in FIG. 2. Likewise, WWW server 200 may further comprise additional mass storage facilities such as CD-ROM/DVD-ROM drive 226 and hard disk drive 228. Hard disk drive 228 is utilized by WWW server 200 to store, among other things, application programs, databases, and program data used by WWW server application 230. For example, customer databases, product databases, image databases, and relational databases may be stored. The operation and implementation of these databases is well known to those skilled in the art.

FIG. 3 depicts several components of client computer 300. Those of ordinary skill in the art will appreciate that client computer 300 may include many more components than those shown in FIG. 3. However, it is not necessary that those generally-conventional components be shown in order to disclose an illustrative embodiment for practicing the present invention. As shown in FIG. 3, client computer 300 includes network interface unit 302 for connecting to a LAN or WAN, or for connecting remotely to a LAN or WAN. Those of ordinary skill in the art will appreciate that network interface unit 302 includes the necessary circuitry for such a connection, and is also constructed for use with various communication protocols including the TCP/IP protocol, the particular network configuration of the LAN or WAN it is connecting to, and a particular type of coupling medium. Network interface unit 302 may also be capable of connecting to the Internet through a point to point protocol (“PPP”) connection or a serial line internet protocol (“SLIP”) connection as known to those skilled in the art.

Client computer 300 also includes BIOS 326, central processing unit 306, video display adapter 308, and memory. The memory generally includes random access memory (“RAM”) 310, read-only memory (“ROM”) 304 and a permanent mass storage device, such as a disk drive. The memory stores operating system 312 and programs 334 for controlling the operation of client computer 300. Programs 334 may include a streaming media player as described in conjunction with FIG. 4. The memory also includes WWW browser 314, such as Netscape's NAVIGATOR® or Microsoft's INTERNET EXPLORER® browsers, for accessing the WWW. It will be appreciated that these components may be stored on a computer-readable medium and loaded into memory of client computer 300 using a drive mechanism associated with the computer-readable medium, such as a floppy drive (not shown), optical drive 316 or some other optical drive, or hard drive 318. Input/output interface 320 may also be provided for receiving input from a mouse, keyboard, or other input device. The memory, network interface unit 302, video display adapter 308, and input/output interface 320 are all connected to central processing unit 306 via bus 322. Other peripherals may also be connected to central processing unit 306 in a similar manner.

FIG. 4 shows an exemplary system in which the invention operates. The system includes client 300, Internet 100, media content servers 405, 410, and 415, proxy server 420, and database 425.

Database 425 may contain user preferences, session information that associates a user with a particular connection, rules for media selection from a media provider including what type of media should be played, how many commercials should be provided, when to play “live” media segments, etc. Database 425 may be distributed, local, or otherwise configured to facilitate access from proxy server 420.

Media content servers 405, 410, and 415 may be connected anywhere on Internet 100. Each media content server may be dedicated to providing a particular type of media. For example, media content server 405 may be dedicated to providing advertising media clips for women's clothing. A media content server may also provide other services besides media delivery. For example, a media content server may provide WWW services for users interested in a particular company's goods or services. Media content servers 405, 410, and 415 are servers like WWW server 200 described in conjunction with FIG. 2 each having a program in programs 234 that provides media clips to requesting streaming media players.

A media content server may provide media for a particular genre of music, e.g., country, oldies, rock, etc. A streaming media player for a user with such preferences may be redirected to a file on an appropriate media content server when proxy server 420 determines that an audio media clip should be delivered.

Client 300 operates as described in conjunction with FIG. 3 and includes a program to play streaming media, such as a Microsoft WINDOWS MEDIA™ player or a RealNetworks media player. Typically, a user uses WWW browser 314 to connect to a media server, such as proxy server 420, and to set user preferences, such as type of media, e.g., country, oldies, classical, news, entertainment, etc. Information regarding a user's tastes may be stored on client 300, proxy server 420, and/or in database 425. For example, while listening to songs, a user may indicate that the user did not like a song, author, or album. A collection of such indications may be stored and used to tailor media delivery to the user's tastes. If such information is stored on client 300, it may be transmitted to the media server, such as proxy server 420, when the client connects to the media server.

When client 300 connects to proxy server 420 through Internet 100, proxy server 420 may retrieve user preferences and may use database 425 to construct a play list to deliver to client 300. Alternatively, proxy server 420 may construct a play list that contains references to media links on proxy server 420. When the streaming media player on client 300 requests a media clip from proxy server 420, at that point, proxy server may use database 425, user preferences, and media programming preferences to redirect the request to a media content server, such as media content servers 405, 410, or 415.

In other words, when the streaming media player on client 300 requests a play list, proxy server 420 may return a “dummy” play list which causes the streaming media player to return to the proxy server to retrieve each media clip. Because the streaming media player has what appears to be a complete play list, the streaming media player can pre-roll subsequent media clips to eliminate gaps between media clips. Pre-rolling refers to the buffering that some streaming media players perform when they have a play list that contains more than one item. Essentially, when a streaming media player has a play list and determines that it is coming to the end of a media clip or that it needs to begin buffering the next media clip to avoid a gap, the streaming media player may begin pre-fetching the next media clip in the play list. But the play list given to the streaming media player may not be an actual play list; rather, it may refer to media clips on a proxy server. When the proxy server receives a request for a media clip, it can then redirect the request to a media content server, thus allowing buffering to eliminate gaps while also providing a means for dynamically assembling media content since the media can be determined when the streaming media player returns to request another item from the play list.

Throughout this disclosure references are made to client 300, a streaming media player on client 300, and a streaming media player connecting to and receiving information from or being redirected by proxy server 420. Which component actually connects to and receives information from proxy server 420 is implementation specific. For example, in some embodiments of the invention, streaming media player directs connection requests through client 300 such that client 300 acts as an intermediary in communicating requests between the streaming media player and proxy server 420. In such cases, saying that client 300 connects to proxy server 420 may imply that streaming media player is also connected to proxy server 420. Typically, streaming media player's requests pass through a component of client 300 such as network interface unit 302 shown in FIG. 3. In other embodiments of the invention, streaming media player directs connection requests to proxy server 420 by directly accessing network interface unit 302. In such cases, saying that the streaming media player is connected to proxy server 420 may imply that streaming media player is connected through client 300 to proxy server 420. When any references to client 300 or the streaming media player connecting to or receiving information from proxy server 420 are made in this disclosure, such references should be construed as meaning that one of the above methods or other appropriate means are used to pass information between proxy server 420, client 300, and/or a streaming media player executing on client 300.

Each streaming media player may require a different format of play list to allow for redirection of subsequent requests for media clips. For example, a play list for a RealNetworks media player may include links to locations for media clips. By causing these links to refer to non-existent files on proxy server 420, proxy server 420 can cause the RealNetworks media player to ask proxy server 420 for each file. When the RealNetworks media player asks proxy server 420 for a file, proxy server 420 can recognize the request and redirect the media player to a file on a media content server.

A play list for a Microsoft WINDOWS MEDIA™ player may include a document that refers to other documents. Each of the references may instruct the player to retrieve a different document from proxy server 420. For example, the first reference may instruct the player to retrieve a document called MediaClip1.ref, while the second reference may instruct the player to retrieve a document called MediaClip2.ref. Each of the other documents may contain information that tells the player where to find a media clip on a media content server. For example, MediaClip1.ref may indicate that a media clip, such as MediaClip1.clp, on one media content server should be retrieved, while MediaClip2.ref may indicate that a media clip, such as MediaClip5.clp, on another media content server should be retrieved. When proxy server 420 receives a request for a referred-to document, such as MediaClip1.ref, at that time, proxy server 420 may create the referred-to document by providing information that locates a dynamically selected media clip. Thus, proxy server 420 may delay determining which media clip should be played until a request for the referred-to document is received. In addition, a Microsoft WINDOWS MEDIA™ player may be configured to wait until it needs to begin buffering the next media clip before it requests the referred-to document. This combination allows media content to be selected dynamically.

It will be understood that the system shown in FIG. 4 allows media selection to be delayed until client 300 requests a media clip without causing undesirable gaps between media clips. This allows a media provider to dynamically insert media clips without introducing gaps. The system shown in FIG. 4 may be modified in many ways including adding proxy servers, media content servers, databases, etc. to provide a more individualized streaming media experience without departing from the spirit and scope of this invention.

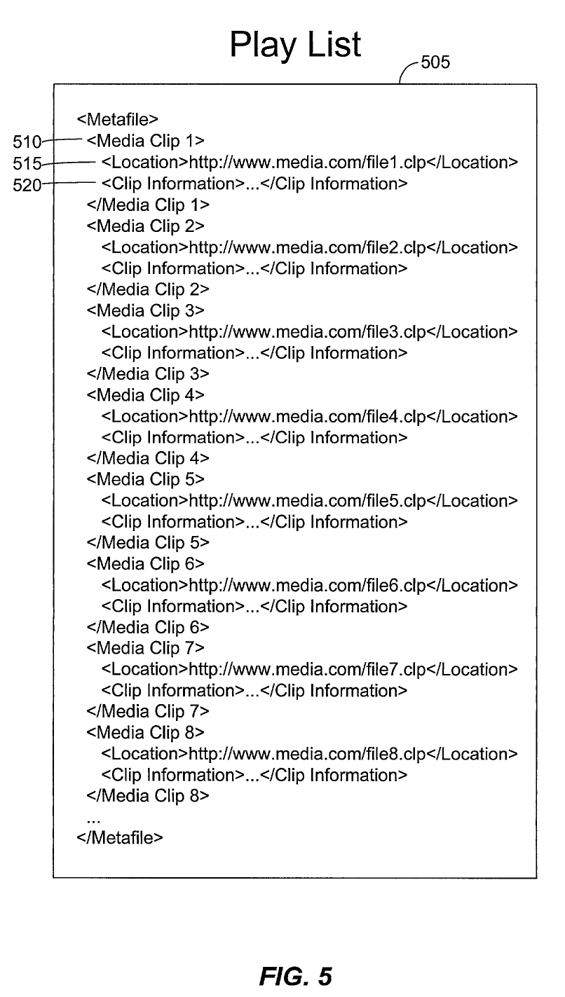

FIG. 5 shows an exemplary partial play list for playing media clips, according to one embodiment of the invention. The play list is shown in a markup language, but could also be implemented as a data structure, a protocol, a program such as JAVA, etc. Play list 505 includes one or more references to media clips, such as reference 510, which may include media clip location information 515 and clip information 520. Clip information 520 may include such things as the title and author of the media, copyright information, a link to a WWW page containing more information about the media, and other information related to the media clip. The title and author of the media, copyright information, and link to the WWW page may include “dummy” information that may be correctly filled in when the streaming media player requests the appropriate media clip from proxy server 420. Media clip location information 515 typically refers to a non-existent file or document on a proxy server, such as proxy server 420.

It will be recognized that location and clip information, such as media clip location information 515 and clip information 520, typically serve as “place holders” to cause the streaming media player to request a media clip, such as http://www.media.com/file1.clp, from a proxy server, such as proxy server 420.

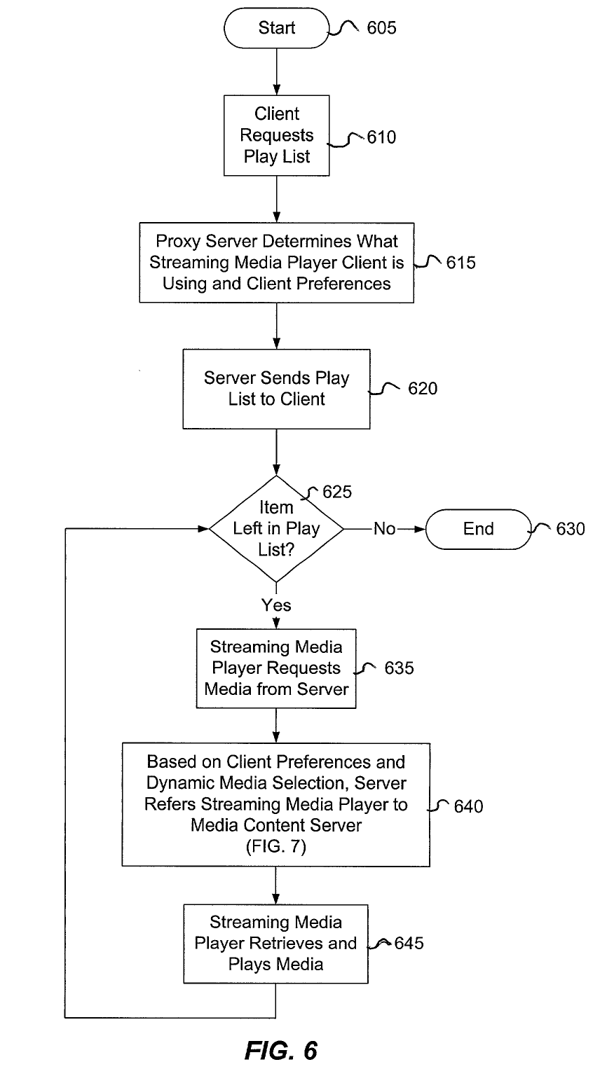

FIG. 6 shows a logical flow diagram illustrating a process for providing media content dynamically, according to one embodiment of the invention. The process begins at block 605 when a streaming media player on a client, such as client 300 of FIG. 4, is ready to request a play list from a server, such as proxy server 420.

At block 610, the streaming media playing on the client requests a play list. For example, referring to FIG. 4, a user on client 300 uses a browser 314 or a streaming media player (not shown) to connect to proxy server 420 and request a play list.

At block 615, the proxy server determines which streaming media player the client is using and may receive or retrieve user preferences. For example, referring to FIG. 4, proxy server 420 determines that client 300 is using a Microsoft WINDOWS MEDIA™ player and receives information from client 300 regarding user preferences as to what types of media the user prefers. Alternatively, proxy server 420 determines that client 300 is using a RealNetworks media player, recognizes client 300 from a cookie stored on client 300 passed to proxy server 420, and retrieves user preferences from database 425.

At block 620, the proxy server sends a play list to the client. The play list may include references to actual media clips, references to media clips on the proxy server that will be redirected to media content servers as the streaming media player requests each clip, or a combination of the two. For example, referring to FIG. 4, proxy server 420 sends a “dummy” play list to client 300 so that the streaming audio player on client 300 will query proxy server 420 for each media clip. Alternatively, proxy server 420 may build an actual play list based on user preferences and send the play list to the client.

At block 625, a loop is entered for playing items on the play list. Each time block 625 is executed, a determination is made as to whether any items are left in the play list. If items are left in the play list, processing continues at block 635; otherwise, the loop is exited and processing ends at block 630. For example, referring to FIG. 4, the streaming media player on client 300 determines that another item exists in the play list.

At block 635, the streaming media player requests a media clip from the proxy server. Typically, as long as a play list includes more than one item, the streaming media player begins requesting the next media clip before the media clip currently being played finishes so as to avoid delays between media clips. For example, referring to FIG. 4, the streaming media play on client 300 requests a media clip from proxy server 420 before the currently playing media clips finishes.

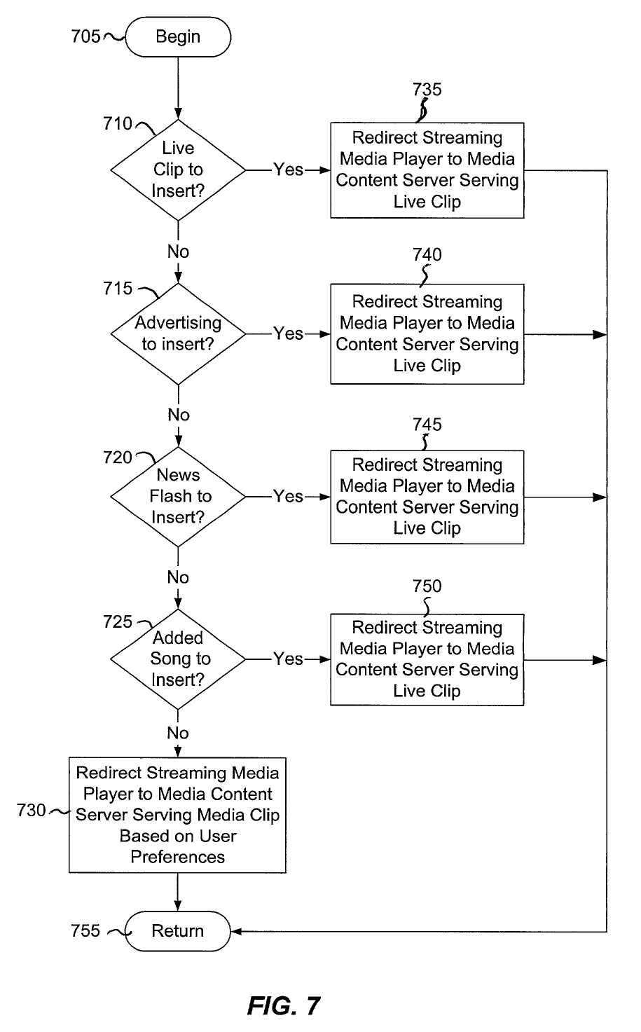

At block 640, the streaming media player is redirected to a media content server for access to the media clip requested at block 635. The appropriate media content server may be selected based on client preferences, a media provider's rules, a dynamic selection inserted by a media provider, or other methods. Some illustrative examples of selecting media are illustrated in FIG. 7 and described in more detail in conjunction therewith. For example, referring to FIG. 4, proxy server 420 uses data 425 to retrieve session information identifying client 300. Proxy server 420 then retrieves user preferences and media provider rules and uses them to select an appropriate media clip. For example proxy server 420 may determine that an advertisement for women's clothing for a sponsoring organization is appropriate. Proxy server 420 then redirects the streaming media player on client 300 to media content server 405, a server dedicated to providing media advertising clips for the women's clothing.

Alternatively, if at block 615, the streaming media player on client 300 is given an actual play list, the streaming media player does not query proxy server 420 for the next media clip. Rather, the actual play list refers to appropriate media content servers and the streaming media player requests media from the media content servers as the play list is played.

At block 645, the streaming media player retrieves the media clip from the media content server the proxy server redirected the streaming media player to. For example, referring to FIG. 4, the streaming media player on client 300 begins retrieving and buffering a women's clothing advertising media clip from media content server 405. When the currently playing media clip finishes, the streaming media player plays the advertisement. This process of requesting media clips continues until the play list has been exhausted.

At block 630, processing ends. At this point, the items in the play list have been requested and played. In the case of a real play list, the streaming media player has used the play list to retrieve media clips from appropriate media content servers. In the case of a “dummy” play list, the streaming media player has requested media clips from a proxy server and then has been redirected to appropriate media content servers. At block 630, the user may request a new play list by starting the process shown in FIG. 6 again.

FIG. 7 shows a logical flow diagram illustrating a process for selecting media content automatically or manually, according to one embodiment of the invention. The process begins at block 605 when a streaming media player on a client, such as client 300 of FIG. 4, requests a media clip from a proxy server, such as proxy server 420. At several of the blocks in FIG. 7, a determination is made as to whether a particular type of media clip should be sent to the streaming media player. Such a determination may be automatically determined through several means, including by rules located on a database or proxy server, or manually by a disc jockey or program manager of the proxy server.

At block 710, a determination is made as to whether a live media clip should be sent to the streaming media player. If a live clip should be inserted, processing continues at block 740; otherwise, processing continues at block 715. For example, referring to FIG. 4, proxy server 420 uses rules on database 425 to determine whether a live media clip should be sent to the streaming media player on client 300.

At block 715, a determination is made as to whether an advertising media clip should be sent to the streaming media player. If an advertising clip should be sent, processing continues at block 740; otherwise, processing continues at block 720. For example, referring to FIG. 4, a program manager managing proxy server 420 determines that an advertising clip should be sent to a set of streaming media players (not shown) one of which resides on client 300.

At block 720, a determination is made as to whether a news flash should be sent to the streaming media player. If a news flash should be sent, processing continues at block 745; otherwise, processing continues at block 725. For example, referring to FIG. 4, proxy server 420 uses rules on database 425 to determine whether a news flash should be sent to the streaming media player on client 300.

At block 725, a determination is made as to whether an additional song should be sent to the streaming media player. For example, a new hit may have been released after the play list was sent to the streaming media player. Alternatively, a listener may call in and request a song. If an additional song should be sent, processing continues at block 750; otherwise, processing continues at block 730. For example, referring to FIG. 4, a listener calls in to request a song and a program manager managing proxy server 420 determines that an additional song should be sent to a set of streaming media players (not shown) one of which is executing on client 300.

At block 730, based on user preferences, the streaming media player requesting a media clip is redirected to a media content server serving media clips. For example, a user may have selected a preference of listening to new country music hits. Referring to FIG. 4, proxy server 420 may retrieve user preferences from database 425 and redirect the streaming audio player on client 300 to media content server 415.

At block 735, the streaming media player requesting a media clip is redirected to a media content server serving live media clips. For example, referring to FIG. 4, proxy server 420 redirects the streaming audio play on client 300 to media content server 410.

At block 740, the streaming media player requesting a media clip is redirected to a media content server serving advertising. For example, referring to FIG. 4, proxy server 420 redirects the streaming audio play on client 300 to media content server 405 to retrieve a media clip advertising women's clothing.

At block 745, the streaming media player requesting a media clip is redirected to a media content server serving news flashes. For example, referring to FIG. 4, proxy server 420 redirects the streaming media player on client 300 to media content server 415.

At block 750, the streaming media player requesting a media clip is redirected to a media content server serving an additional song. For example, referring to FIG. 4, proxy server 420 redirects the streaming audio play on client 300 to media content server 410.

At block 755, processing returns to the calling process. At this point, the streaming audio player requesting a media clip has been referred to an appropriate media content server and may begin retrieving a media clip to play.

The various embodiments of the invention are implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit and scope of the present invention as recited within the claims attached hereto.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method for continuously playing media clips, comprising:
creating a play list to be used on a client, wherein the play list includes a plurality of references used to request media clips;
sending the play list to the client;
receiving a request for a media clip associated with one of the plurality of references; and
redirecting the request to a media server, wherein a dynamically selected media clip is substituted for the requested media clip.

2. The method of claim 1 wherein the client includes a media player.

3. The method of claim 2 wherein the client is a media player.

4. The method of claim 1 wherein the play list includes references to dummy media clips used to redirect requests.

5. The method of claim 1 wherein redirecting the request comprises applying rules to determine the substituted clip on the media server.

6. The method of claim 1 wherein redirecting the request comprises:
receiving user input; and
selecting the media server to redirect the request to using the user input.

7. The method of claim 1 wherein redirecting the request comprises:
retrieving preference data; and
selecting the media server to redirect the request to using the preference data.

8. The method of claim 7 wherein the preference data is located on the client.

9. The method of claim 7 wherein the preference data is retrieved from a database.

10. A system for continuously playing a plurality of media clips, comprising:
a client including a streaming media player;
a server coupled to the client, wherein the server creates a play list which causes the streaming media player to query the server for each of the plurality of media clips, and wherein the server responds to at least one query by redirecting the client to a media server.

11. The system of claim 10 wherein the server creates the play list using preferences.

12. The system of claim 11 wherein the preferences are stored on the client.

13. The system of claim 11, further comprising a database coupled to the server, wherein the preferences are stored on the database.

14. The system of claim 10, further comprising a database.

15. The system of claim 14 wherein the database includes rules for redirecting the client to the media server.

16. The system of claim 14 wherein the database includes preferences used in redirecting the client to the media server.

17. A computer-readable medium including computer-executable components for continuously playing media clips in a play list using a player that requests and buffers a next media clip in the play list prior to a currently playing media clip finishing, comprising:
a server including:
a generator that automatically generates the play list, wherein the play list includes at least one reference that causes the player to request information associated with a media clip from the server, and
a redirector that receives the player's request and automatically redirects it to a media content server using a user preference and a media provider preference.

18. The computer-readable medium of claim 17 wherein the media provider preference comprises rules for selecting the media content server.

19. The computer-readable medium of claim 17 wherein the media provider preference comprises user inputted data.

20. An apparatus for continuously playing media clips, comprising:
means for generating a play list;
means for requesting, receiving, and playing a media clip using the play list; and
means for redirecting each request for the media clip to a media server.
